(19) United States
(12) Patent Application Publication
(10) Pub. No.: US 2017/0322185 A1
(43) Pub. Date: Nov. 9, 2017

(54) MACHINE ROTOR ULTRASONIC IMAGING SYSTEM AND RELATED METHODS

(71) Applicant: General Electric Company, Schenectady, NY (US)

(72) Inventors: Paul Howard Davidson, Albany, NY (US); Robert William Bergman, Scotia, NY (US); Michael Charles Freda, Long Beach Township, NJ (US); Kurt Neal Laurer, Saratoga Springs, NY (US); Robert Charles Malison, Schenectady, NY (US); Thomas Earnest Moldenhauer, Burnt Hills, NY (US); August Elwood Pendergast, Greenfield Center, NY (US); Francis Alexander Reed, Duanesburg, NY (US); John Matthew Sassatelli, Valley Falls, NY (US)

(21) Appl. No.: 15/149,835

(22) Filed: May 9, 2016

(51) Int. Cl. G01N 29/26; G01N 29/265; F01D 21/00

(52) U.S. Cl. CPC G01N 29/262; F01D 21/003; G01N 29/265

(57) ABSTRACT

Various embodiments include an ultrasonic detection method, performed using an ultrasonic detection system having a set of corresponding transmitting phased array devices and receiving phased array devices, the method including: for each of a plurality of static positions about a portion of a machine rotor: transmitting, at a corresponding transmitting phased array device, a set of ultrasonic waves through the portion of the machine rotor, and receiving, at the corresponding receiving phased array device, the set of ultrasonic waves after transmission through the portion of the machine rotor, to obtain a set of ultrasonic detection information about the machine rotor; and forming an ultrasonic representation of the machine rotor by aligning the sets of the ultrasonic detection information about the machine rotor obtained from each of the plurality of static positions about the portion of the machine rotor.

### FIELD OF THE INVENTION

The subject matter disclosed herein relates to machines such as turbomachines. More particularly, the subject matter disclosed herein relates to ultrasonic imaging of machines, e.g., rotatable machines such as turbomachine rotors.

### BACKGROUND OF THE INVENTION

The inspection of large objects (such as, steam turbine rotors) can be very difficult. Such inspection can be important for identifying features, such as, asperities, voids, defects, fatigued material, cracks, and/or material variations. In large objects, nondestructive techniques are limited based upon the size of the objects, based upon the complexity of the objects, and/or based upon the materials of the objects. A failure to identify such features can result in extended repair cycles, limiting availability of operation, and/or system failure.

Some commercial inspection systems are available to provide the inspection of large objects. Known ultrasonic techniques use single probe approaches, limiting the volume of material that can be inspected in a single pass. For example, one known technique, pulse echo, is limited to covering a small volume of a cylindrical solid rotor material in a single pass. To achieve such inspection in a nondestructive manner, ultrasonic systems can require complex and/or repeated analysis, can require advanced motion control and/or complex probe positioning control, and combinations thereof, resulting in high costs.

### BRIEF DESCRIPTION OF THE INVENTION

Various embodiments include an ultrasonic detection method, performed using an ultrasonic detection system having a set of corresponding transmitting phased array devices and receiving phased array devices, the method including: for each of a plurality of static positions about a portion of a machine (e.g., rotatable machine such as turbomachine or dynamoelectric machine) rotor: transmitting, at a corresponding transmitting phased array device, a set of ultrasonic waves through the portion of the machine rotor, and receiving, at the corresponding receiving phased array device, the set of ultrasonic waves after transmission through the portion of the machine rotor, to obtain a set of ultrasonic detection information about the machine rotor; and forming an ultrasonic representation of the machine rotor by aligning the sets of the ultrasonic detection information about the machine rotor obtained from each of the plurality of static positions about the portion of the machine rotor.

A first aspect of the disclosure includes an ultrasonic detection method, performed using an ultrasonic detection system having a transmitting phased array device and a receiving phased array device, the method including: transmitting, at the transmitting phased array device, a first set of ultrasonic waves through a first portion of a machine (e.g., rotatable turbomachine or dynamoelectric machine) rotor at a first static position, and receiving, at the receiving phased array device, the first set of ultrasonic waves after transmission through the portion of the machine rotor, to obtain a first set of ultrasonic detection information about the machine rotor; transmitting, at the transmitting phased array device, a second set of ultrasonic waves through a second portion of the machine rotor at a second static position, and receiving, at the receiving phased array device, the second set of ultrasonic waves after transmission through the second portion of the machine rotor, to obtain a second set of ultrasonic detection information about the machine rotor; and forming an ultrasonic representation of the machine rotor by aligning the first set of ultrasonic detection information about the machine rotor with the second set of ultrasonic detection information about the machine rotor.

A second aspect of the disclosure includes a system having: an ultrasonic detection system for analyzing a machine (e.g., rotatable machine such as a turbomachine or dynamoelectric machine) rotor, the ultrasonic detection system having a transmitting phased array device and a receiving phased array device; and at least one computing device coupled with the ultrasonic detection system, the at least one computing device configured to: instruct the transmitting phased array device to transmit a first set of ultrasonic waves through a first portion of a machine rotor at a first static position, and receive, from the receiving phased array device, the first set of ultrasonic waves after transmission through the portion of the machine rotor, to obtain a first set of ultrasonic detection information about the machine rotor; instruct the transmitting phased array device to transmit a second set of ultrasonic waves through a second portion of the machine rotor at a second static position, and receive, at the receiving phased array device, the second set of ultrasonic waves after transmission through the second portion of the machine rotor, to obtain a second set of ultrasonic detection information about the machine rotor; and form an ultrasonic representation of the machine rotor by aligning the first set of ultrasonic detection information about the machine rotor with the second set of ultrasonic detection information about the machine rotor.

A third aspect of the disclosure includes an ultrasonic detection method, performed using an ultrasonic detection system having a set of corresponding transmitting phased array devices and receiving phased array devices, the method including: for each of a plurality of static positions about a portion of a machine (e.g., rotatable machine such as a turbomachine or dynamoelectric machine) rotor: transmitting, at a corresponding transmitting phased array device, a set of ultrasonic waves through the portion of the machine rotor, and receiving, at the corresponding receiving phased array device, the set of ultrasonic waves after transmission through the portion of the machine rotor, to obtain a set of ultrasonic detection information about the machine rotor; and forming an ultrasonic representation of the machine rotor by aligning the sets of the ultrasonic detection information about the machine rotor obtained from each of the plurality of static positions about the portion of the machine rotor.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 is a perspective view of an ultrasonic detection system with a reflecting feature at a first position within an object analyzed by an embodiment of an ultrasonic detection method according to the disclosure.

FIG. 2 is a perspective view of an ultrasonic detection system with a reflecting feature at a second position within an object analyzed by an embodiment of an ultrasonic detection method according to the disclosure.

FIG. 3 shows a flow diagram illustrating a method performed according to various embodiments of the disclosure.

FIG. 4 illustrates an example ultrasonic inspection system for inspecting turbine components in accordance with certain embodiments of the disclosure.

FIG. 5 shows an example turbine rotor with inspection regions according to various embodiments of the disclosure.

FIG. 6 shows an example scanning configuration for an ultrasonic inspection of a turbine component in accordance with various embodiments of the disclosure.

FIG. 7 shows an example scanning configurations for ultrasonic inspection of a turbine component in accordance with certain embodiments of the disclosure.

FIG. 8 illustrates an example transducer element array according to various embodiments of the disclosure.

FIG. 9 shows an example transducer element matrix of a turbine component in accordance with certain embodiments of the disclosure.

FIG. 10 shows an environment including an ultrasonic control system according to various embodiments of the disclosure.

It is noted that the drawings of the invention are not necessarily to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the subject matter disclosed herein relates to rotatable machines such as turbomachines. More particularly, the subject matter disclosed herein relates to ultrasonic detection and analysis of rotatable machines such as turbomachines, (e.g., steam turbines or gas turbines) or dynamoelectric machines (e.g., generators or motors).

In the following description, reference is made to the accompanying drawings that form a part thereof, and in which is shown by way of illustration specific example embodiments in which the present teachings may be practiced. These embodiments are described in sufficient detail to enable those skilled in the art to practice the present teachings and it is to be understood that other embodiments may be utilized and that changes may be made without departing from the scope of the present teachings.

Various embodiments include approaches for ultrasonic imaging (e.g., detection and analysis) of machines such as turbomachines. Embodiments of the present disclosure, in comparison to methods not utilizing one or more features disclosed herein, permit nondestructive analysis of features in large solid or substantially solid objects, reduce or eliminate repair and/or inspection cycles, utilize one or more probes in a pulse-echo manner, utilize two or more probes in a pitch-catch manner, avoid integration of probes into large bodies, or a combination thereof. It is understood that various embodiments of the disclosure can be applied to any rotatable machine, e.g., turbomachines such as steam turbines or gas turbines, as well as dynamoelectric machines such as generators or motors. Examples using particular types of rotating machines are merely illustrative, and not limiting of the various aspects of the disclosure.

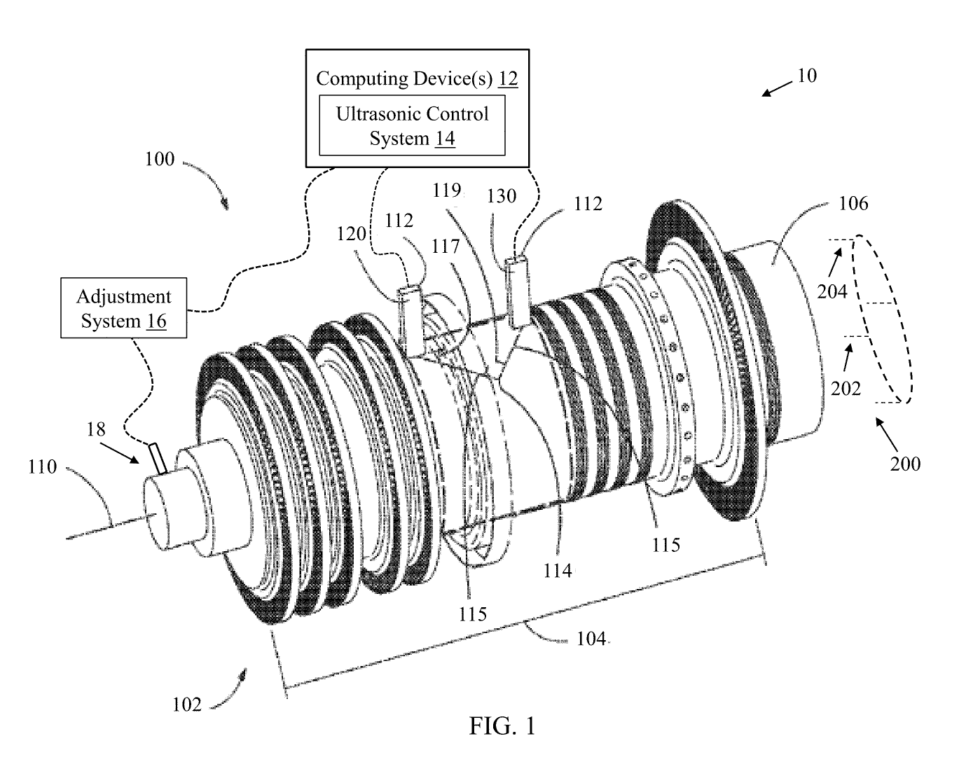

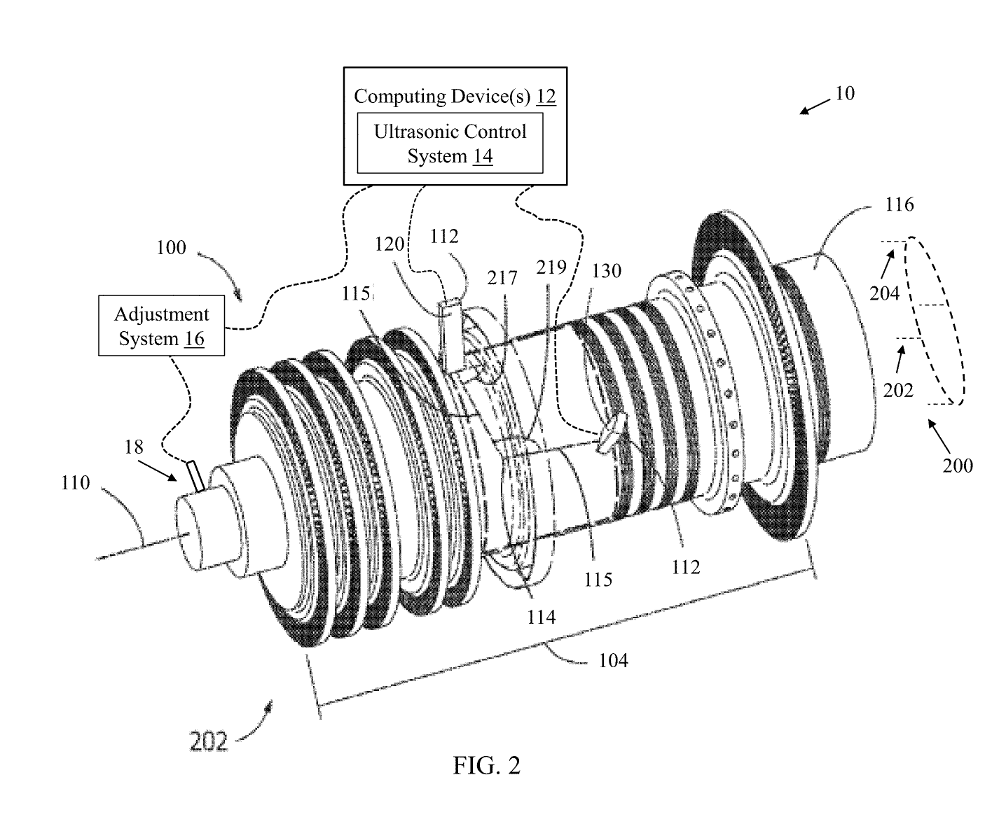

FIGS. 1 and 2 show embodiments of a system 10 including at least one computing device 12 having an ultrasonic control system 14. Computing device(s) 12 can be coupled with an ultrasonic detection system 100 for performing an ultrasonic detection method according to various embodiments. Ultrasonic detection system 100 includes one or more ultrasonic phased array devices 112 arranged with respect to a portion of turbomachine rotor 106 to be measured. Portion of turbomachine rotor (also called “rotor” or “turbomachine rotor” herein) 106 is rotatable about a centerline, and is any suitable object including, but not limited to, objects manufactured from a monolithic forging, such as, a turbine rotor, a shaft of a solid steam rotor, a portion underneath a turbine rotor wheel, a rotor body, a coupling or a blade attachment. It is understood that while various embodiments described herein focus on cylindrical objects (e.g., rotors and related shafts), these embodiments could be employed in analyzing non-cylindrical rotating machines having polar symmetry (e.g., a hydroelectric generator).

In some cases, system 10 can further include an adjustment system 16 coupled with computing device(s) 12 and (portion of) turbomachine rotor 106 (connections/couplings described herein can be hard-wired and/or wireless, and are depicted in some cases in phantom to suggest a data connection). Adjustment system 16 can include one or more adjustment devices 18 configured to adjust turbomachine rotor 106 between positions and/or retain turbomachine rotor 106 in a given position. In some cases, adjustment devices 18 can include a crawler or roller, which may include a rotary encoder and/or plumb-bob to record position. In some cases, adjustment devices 18 can include hydraulic, piezoelectric, pneumatic or other actuators configured to modify and/or retain the position of turbomachine rotor 106. In various embodiments, ultrasonic control system 14 can instruct adjustment system 16 to modify a position of turbomachine rotor 106 via one or more adjustment devices 18. As described herein, these adjustments may be performed in order to capture ultrasound data about turbomachine rotor 106 at various positions in order to form an ultrasonic representation of a portion of turbomachine rotor 106.

In one embodiment, the turbomachine rotor 106 has a mass of greater than about 3 Tons, between about 3 Tons and about 150 Tons, between about 3 Tons and about 50 Tons, between about 50 Tons and about 100 Tons, between about 100 Tons and about 150 Tons, about 50 Tons, about 100 Tons, about 150 Tons, about 200 Tons, about 250 Tons or any suitable combination, sub-combination, range, or sub-range therein. In one embodiment, features are machined into the shaft surface. The features form an area for phased array devices 112 for positioning and/or securing, and can include wheel faces, packing faces, packing grooves, shaft steps, etc.

Phased array devices 112 are configured for transmitting and/or receiving a set of ultrasonic waves or beams 115. According to various embodiments of the disclosure, a full-matrix capture method can include transmitting and/or receiving a set of ultrasonic waves or beams 115 that includes a plurality of ultrasonic waves or beams 115 (e.g., set is greater than one). According to various other embodiments, such as in a standard beam forming technique, the set of ultrasonic waves or beams 115 can include a single ultrasonic wave or beam 115 (set is equal to one). Phased array devices 112 are grouped into arrangements, each arrangement including a transmitting phased array device 120 and a receiving phased array device 130. In one embodiment, transmitting phased array device 120 is positioned relative to receiving phased array device 130 to generate a field through a predetermined volume of turbomachine rotor 106. In one embodiment, the arrangement is situated on a periphery of turbomachine rotor 106, and configured to transmit the ultrasonic wave or beam 115 from transmitting phased array device 120 to receiving phased array device 130, thereby obtaining ultrasonic detection information relating to turbomachine rotor 106. In various embodiments, e.g., where phased array devices 112 are used for pulse-echo measurement, the transmitting phased array device 120 and receiving phased array device 130 may be the same component (e.g., a device with both transmitting and receiving capability) and/or be housed within the same component.

In one embodiment, the positioning of phased array devices 112 is adjusted to provide a desired degree of interrogation by the ultrasonic wave or beam 115. In a further embodiment, the positioning of phased array devices 112 is automated to provide the desired degree of interrogation by the ultrasonic wave or beam 115. In one embodiment, phased array devices 112 are substantially planar. Phased array devices 112 can have a plurality of elements and sub-elements, the sub-elements being transducers (for example, 4 sub-elements, 8 sub-elements, 16 sub-elements, 32 sub-elements, 64 sub-elements, 128 sub-elements, 256 elements or 512 elements), a predetermined operational frequency (for example, including, but not limited to, between about 1 MHz and about 10 MHz), or a combination thereof.

In one embodiment, the ultrasonic wave or beam 115 travels through a portion of turbomachine rotor 106 to determine the presence or absence of a reflecting feature 114. Reflecting feature 114 is a discontinuity within turbomachine rotor 106, the discontinuity including, but not limited to, a void, a defect-fatigued material, a crack, corrosion, another material difference, or a combination thereof. In the absence of reflecting feature 114 being within the path of the ultrasonic wave or beam 115, the phase array wave or beam 115 is not reflected. In the presence of the reflecting feature being within the path of ultrasonic wave or beam 115, the ultrasonic wave or beam 115 is reflected and/or refracted or otherwise modified. In the absence of reflecting feature 114, the arrangement (including the transmitting phased array device 120 and receiving phased array device 130) is moved incrementally along circumferentially about turbomachine rotor 106 to detect a presence of the reflecting feature 114 in turbomachine rotor 106. In another embodiment, turbomachine rotor 106 is stationary and the arrangement is moved circumferentially about turbomachine rotor 106. In one embodiment, turbomachine rotor 106 is rotated axially about centerline 110, using adjustment system 16 (including adjustment devices 18) at between about 4 and about 5 rotations per minute, about 3 and about 4 rotations per minute, about 2 and about 3 rotations per minute, about 1 and about 2 rotations per minute, between about 0.5 and about 1.5 rotations per minute, between about 0.5 and about 1 rotation per minute, between about 1 and about 1.5 rotations per minute, between about 1.5 and about 2 rotations per minute, or any suitable combination, sub-combination, range, or sub-range therein.

In one embodiment, ultrasonic detection system 100 is used to detect and evaluate reflecting features 114 detected through the incremental movement of the arrangement (including transmitting phased array device 120 and receiving phased array device 130) and/or found by other methods, such as pulse echo. It is understood that the process of detecting, as used herein, includes identification of a possible indication or anomaly within the structure of rotor 106. Evaluation, as used herein, can include characterizing the indication or anomaly to better determine its size and/or morphology. This evaluation can be performed ultrasonically using more detailed methods than are necessary for the identification or detection phase of the inspection. Ultrasonic detection system 100 is positioned relative to a location corresponding to reflecting feature 114, and the ultrasonic wave or beam 115 obtains ultrasonic detection information including amplitude, time-of-flight, frequency content, and other waveform characteristics relating to reflecting feature 114 within turbomachine rotor 106. In various embodiments, the waveform amplitude is the primary detection characteristic for identifying possible indications (e.g., characteristic such as anomaly). Time-of-flight can be used to locate the indication within the body of turbomachine rotor 106, while the frequency content of the reflected waveform can provide information about the size and/or orientation of the indication (e.g., characteristic such as anomaly). In one embodiment, the ultrasonic wave or beam 115 from transmitting phased array device 120 contacts reflecting feature 114, where reflecting feature 114 distorts the ultrasonic wave or beam 115. The ultrasonic wave or beam 115 is distorted by parameters of reflecting feature 114 such as, but not limited to, size, orientation relative to incident sound wave or beam, morphology, sound path travel, and suitable combinations thereof.

Analysis of the ultrasonic wave or beam 115 received by receiving phased array device 130 provides information about the presence and/or parameters of reflecting feature 114. The information obtained characterizes a morphology of reflecting feature 114, the morphology including, but not limited to, size, shape, volumetric shape and/or flaw, orientation, geometric and material aspects, or a combination thereof. Re-positioning of phased array devices 112 on the periphery of turbomachine rotor 106 obtains responses from various perspectives of the same reflecting feature 114. In one embodiment, the ultrasonic detection information relating to reflecting feature 114 includes, but is not limited to, location, orientation, size, validity of reflecting feature 114 detected, and combinations thereof.

Transmitting phased array device 120 and receiving phased array device 130, in general, are positioned at an angle with respect to each other and/or turbomachine rotor 106. Transmitting phased array device 120 emits the ultrasonic wave or beam 115 at a predetermined transmission angle. In one embodiment, the predetermined transmission angle is adjustable. In one embodiment, the angles of transmitting phased array device 120 and receiving phased array device 130 differ. In one embodiment, the angles of transmitting phased array device 120 and receiving phased array device 130 are the same or substantially the same. In various embodiments, the angles of transmitting phased array device 120 and receiving phased array device 130 are correlated to identify the location/orientation of a feature (e.g., defect) on rotor 106.

Suitable transmitting angles for receiving phased array device 130 and/or transmitting phased array device 120 are, but are not limited to, being arranged relative to a parallel of centerline 110, between about 0 degrees and about 90 degrees, between about 1 degree and about 89 degrees, between about 0 degrees and about 80 degrees, between about 0 degrees and about 70 degrees, between about 10 degrees and about 80 degrees, between about 10 degrees and about 60 degrees, between about 45 degrees and about 80 degrees, between about 30 degrees and about 60 degrees, between about 30 degrees and about 45 degrees, between about 45 degrees and about 60 degrees, at about 10 degrees, at about 30 degrees, at about 45 degrees, at about 60 degrees, at about 80 degrees, or any suitable combination, sub-combination, range, or sub-range therein.

For example, referring to FIG. 1, phased array devices 112 are situated in a first position 102. In first position 102 the ultrasonic wave or beam 115 exits transmitting phased array device 120 at a first transmission angle 117 and reflects off of reflecting feature 114, forming a first reflection angle 119. Referring to FIG. 2, phased array devices 112 are situated in a second position 202. In the second position 202 the ultrasonic wave or beam 115 exits transmitting phased array device 120 at a second transmission angle 217 and reflects off reflecting feature 114, forming a second reflection angle 219. In one embodiment, first transmission angle 117 is the same as second transmission angle 217, and forms the first reflection angle 119 different from the second reflection angle 219. In one embodiment, first transmission angle 117 differs from second transmission angle 217, and forms the first reflection angle 119 different from the second reflection angle 219.

In one embodiment, the ultrasonic wave or beam 115 is skewed to obtain data from, but not limited to, an area not directly accessible by phase array devices 112. Skewing the ultrasonic wave or beam 115 includes rotating the ultrasonic wave or beam 115 exiting transmitting phased array device 120 about a surface normal. As is known in the art, two angles are used to define the vector and sound wave, where a first angle is relative to the axial datum, and the other is relative to the circumferential datum. That is, according to embodiments, a refracted angle of the beam is used as a first angle, and a skew angle is used as a second angle, where the skew angle defines the orientation of the refracted beam relative to the local axial and circumferential coordinates.

In one embodiment, ultrasonic detection system 100 includes a plurality of the arrangements (each of the arrangements includes transmitting phased array device 120 and receiving phased array device 130). The arrangements are situated in multiple positions on turbomachine rotor 106, the receiving phased array devices 130 of the arrangements obtaining the ultrasonic detection information from different perspectives. The ultrasonic detection information from the arrangements is combined and analyzed with respect to various signal attributes, providing improved accuracy relating to reflecting feature 114 within turbomachine rotor 106.

In contrast to conventional approaches, various embodiments of the disclosure include methods of analyzing a turbomachine, e.g., a turbine rotor, using a plurality of statically-obtained measurements. That is, various embodiments of the disclosure involve probing (across all probes) a turbomachine rotor at a static position; subsequently changing the position of the rotor relative to those probes (e.g., rotating the rotor to a second static position and/or changing the static position of the probes (distinct from first static position), and probing the rotor again (across all probes); repeating this process until the rotor has been probed at each interval (position); and overlaying the ultrasound data from each rotor position to create a representation of the rotor. Compared with the conventional approaches, this process can significantly simplify overlaying data, as well as integration of software. This approach can be particularly useful with ultrasonic detection system 100, which utilizes phased-array technology.

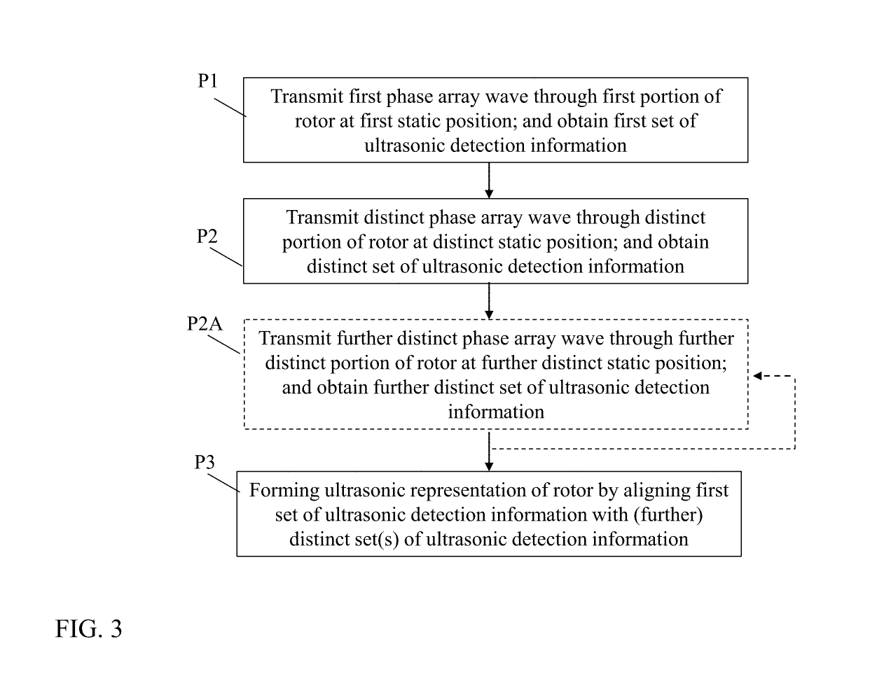

FIG. 3 shows a flow diagram illustrating processes according to various embodiments of the disclosure. These processes can be performed, for example, by a computing device 12, including ultrasonic control system 14, and acting in concert with one or more of adjustment system 16 and ultrasonic detection system 100. In other cases, these processes can be performed according to a computer-implemented method of analyzing turbomachine rotor 106. In still other embodiments, these processes can be performed by executing computer program code (e.g., ultrasonic control system 14) to monitor turbomachine rotor 106. These processes are described with continuing reference to FIGS. 1 and 2, and include:

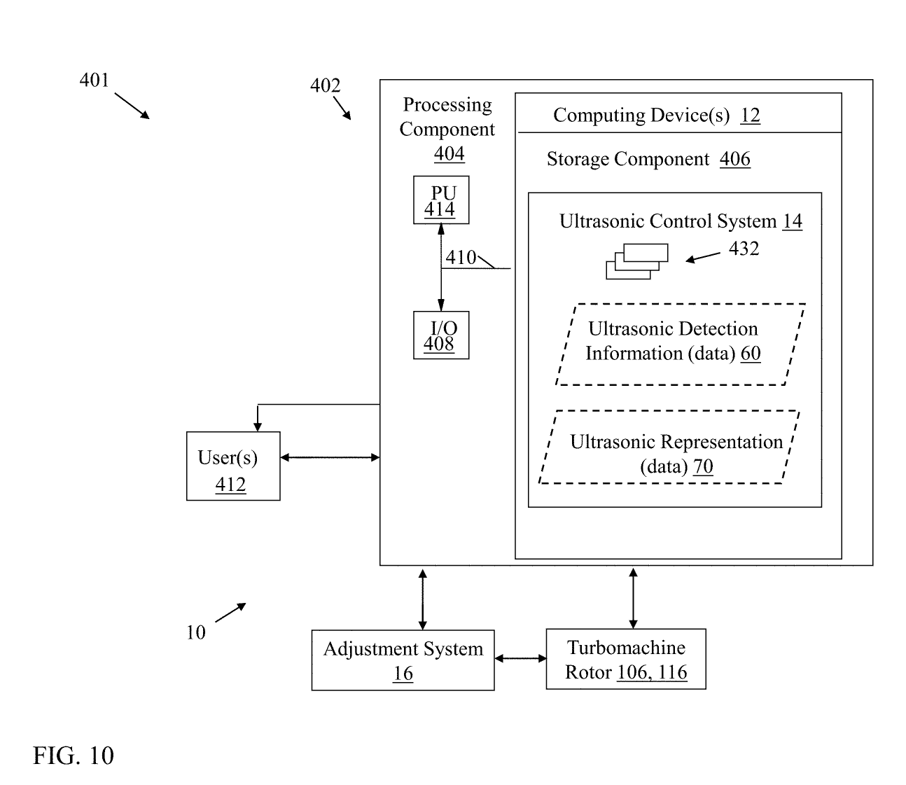

Process P1: transmitting, at transmitting phased array device 120, a first ultrasonic wave through a first portion of turbomachine rotor 106 (or 116, FIG. 2) at a first static position 200, and receiving, at receiving phased array device 130, the first ultrasonic wave after transmission through the portion of turbomachine rotor 106, 116, to obtain a first set of ultrasonic detection information about turbomachine rotor 106, 116. As shown in FIGS. 1 and 2, a phantom circumferential outline of the body of turbomachine rotor 106, 116 is shown to illustrate the location of various static positions 200, 202, 204, etc. It is understood that any number of static positions may exist for rotating turbomachine rotor 106, 116 (about centerline (axis) 110). These figures merely illustrate the principal that the various processes described herein can be utilized to obtain ultrasonic information 60 (FIG. 10) about turbomachine rotor 106, 116 at various static positions 200, 202, 204, etc. It is understood that as discussed herein, a plurality of phased array devices 112 can be located about turbomachine rotor 106, 116, and in some cases, phased array devices 112 are located at second locations on the rotor, e.g., as shown in depiction of rotor 116 in FIG. 2. According to various embodiments, each transmitting phased array device 120 and receiving phased array device 130 may probe a plurality of locations on rotor 106, 116 during each transmission, thereby providing information about a various portions of rotor 106, 116.

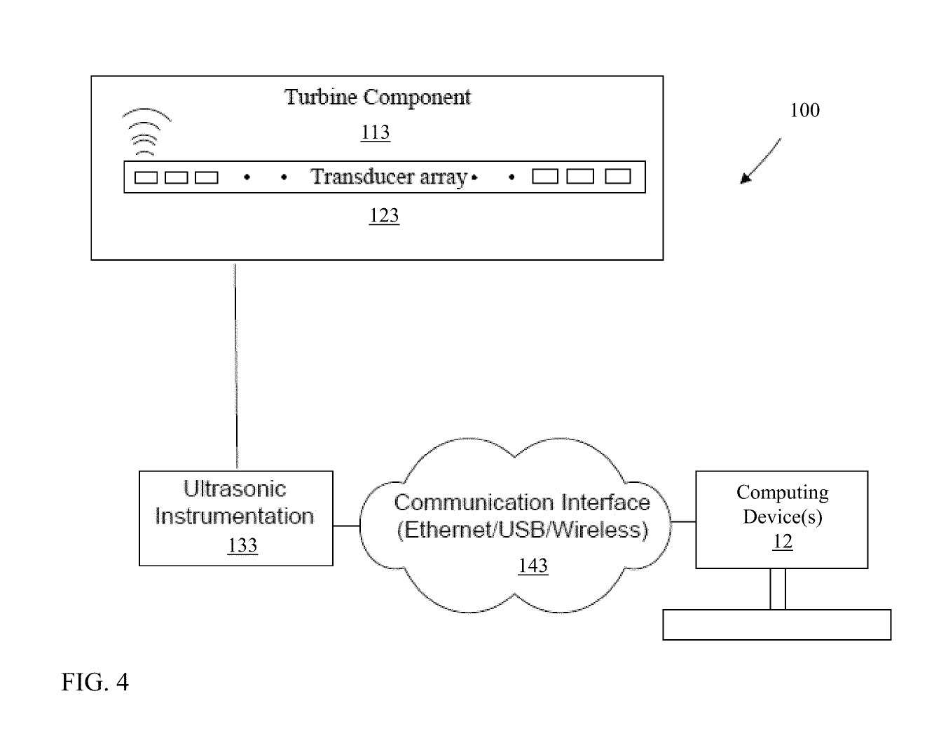

Process P2 (following process P1 in various embodiments): transmitting, at transmitting phased array device 120, a second ultrasonic wave through a second portion of turbomachine rotor 106 (or 116, FIG. 2) at a second static position 202 (distinct from first static position 200), and receiving, at receiving phased array device 130, the second ultrasonic wave after transmission through second portion of turbomachine rotor 106, 116, to obtain a second set of ultrasonic detection information 60 (FIG. 4) about turbomachine rotor 106, 116. According to various embodiments, ultrasonic control system 14 can instruct adjustment system 16 to adjust the position of rotor 106 (or 116, FIG. 2) to second (distinct) static position 202, 204, 206, etc. prior to initiating transmission of the second phased array wave. This second static position 202, 204, 206, etc., can include a position that is circumferentially off-set from first static position 200, that is, less than 360 degrees of rotation from first static position 200 in either rotational direction.

Process P3 (following processes P1 and P2 in various embodiments): forming an ultrasonic representation 70 (FIG. 10) of turbomachine rotor 160, 116 by aligning the first set of ultrasonic detection information 60 about turbomachine rotor 106, 116 with the second set of ultrasonic detection information 60 about turbomachine rotor 106, 116. According to various embodiments, ultrasonic representation 70 can be substantially more accurate than representations formed according to conventional approaches. For example, data reduction need not be performed in a continuous manner, and noise in the ultrasonic data is reduced when compared with conventional approaches, providing a clearer representation.

In various embodiments, the above-noted process can include an additional intermediate step, shown as process P2A, which includes: transmitting, at transmitting phased array device 130, a third ultrasonic wave through a third portion of turbomachine rotor 106 (or 116, FIG. 2) at a third static position 204 (and/or 206, 208, 210, etc.), distinct from first and second static positions 200, 202, and receiving, at receiving phased array device 130, the third ultrasonic wave after transmission through the third portion of turbomachine rotor 106 (or 116, FIG. 2), to obtain a third set of ultrasonic detection information 60 about turbomachine rotor 106, 116. According to various embodiments, ultrasonic control system 14 can instruct adjustment system 16 to adjust the position of rotor 106 (or 116, FIG. 2) to third static position 204, 206, etc., prior to initiating transmission of the third phased array wave.

In various embodiments, Process P2A (transmitting and receiving of the third ultrasonic wave at the third static position 204) is repeated for a plurality of distinct phase array waves at a plurality of distinct static positions 206, 208, 210, etc. (distinct from first, second and third positions 200, 202, 204) until ultrasonic detection information 60 is obtained from each of the static positions 206, 208, 210, etc. about portion of rotor 106.

In these embodiments, process P3 can include forming ultrasonic representation 70 by aligning the first set of ultrasonic detection information 60, the second set of ultrasonic detection information 60, and the third set(s) of ultrasonic detection information 60.

It is understood that processes P1-P3 can be iterated on a periodic basis. Additionally, these processes can be repeated according to any schedule to monitor turbomachine rotor 106, 116 as described herein.

It is understood that in the flow diagrams shown and described herein, other processes may be performed while not being shown, and the order of processes can be rearranged according to various embodiments. Additionally, intermediate processes may be performed between one or more described processes. The flow of processes shown and described herein is not to be construed as limiting of the various embodiments.

FIG. 4 shows an example close-up view of ultrasonic detection system 100 of FIG. 1, for implementing certain methods and systems for ultrasonic inspection of turbine components, in accordance with one or more example embodiments. System 100 may include a turbine component 113 (within portion of turbomachine 106, 116), such as a gas turbine or steam turbine component. For example, a gas turbine or steam turbine component can include, but may not be limited to, a turbine rotor, turbine wheel, turbine blade, or turbine casing. In various embodiments, it is understood that components may include dynamoelectric machine components such as windings, shafts, couplings, etc. System 100 can include at least one array of transducer elements 123, ultrasonic instrumentation 133 (such as transmitting phased array device 120 and receiving phased array device 130) and computing device(s) 12. As shown in FIG. 1, at least one array of transducer elements 123 can be mounted to the turbine component 113 of interest. The at least one array of transducer elements 123 can be connected to the ultrasonic instrumentation 133. The computing device(s) 12 can be communicatively coupled to the ultrasonic instrumentation 133 via a communication interface 143, which can be any of one or more communication networks such as, for example, an Ethernet interface, a Universal Serial Bus (USB) interface, or a wireless interface. In certain embodiments, as described herein, the computing devices(s) 12 can be coupled to the ultrasonic instrumentation 133 by way of a hard wire or cable, such as a computer or network interface cable. For example, an Ethernet or USB cable can be used to connect computing devices(s) 12 and ultrasonic instrumentation 133. In other embodiments, additional system elements (not shown) can be included, such as an ultrasonic pulser-receiver, a matrix array controller, a digital oscilloscope as well as additional software for analysis and anomaly detection.

The at least one array of transducer elements 123 can be one or more arrays of transducer elements or probes. For example, transducer probes can include monocrystal transducer probes, dual-element transducer probes or multi-element phased array transducer probes. The ultrasonic instrumentation 133 can be one or more acquisition units for transmitting and capturing signals from the turbine component 113 of interest, ultrasonic pulser-receiver, a matrix array controller, a digital oscilloscope, a motion control drive unit or a transducer scanner.

In some cases, computing devices(s) 12 can also interact with the ultrasonic instrumentation 133 to provide notifications concerning possible anomalies of the turbine component 113 to an operator or another user, based on which preventative action can be taken, and so forth. In some embodiments, the ultrasonic instrumentation 133 may reside as part of the computing devices(s) 12. Alternatively, computing devices(s) 12 can be an independent entity communicatively coupled to ultrasonic instrumentation 133.

In accordance with an embodiment of the disclosure, a full matrix capture approach to ultrasonic inspection of turbine component can be implemented. With respect to FIG. 4, each transducer element of the at least one array of transducer elements 123 can be pulsed separately to transmit a signal to the turbine component 110 of interest. The reflected signals from the turbine component 110 can be captured at each transducer element in the at least one array of transducer elements 120, and communicated to the computer 150. During the signal transmission and capturing of reflected signals, the at least one array of transducer elements 120 can be maintained at a constant relative position with respect to the turbine component 110.

The captured reflected signals communicated to the computing devices(s) 12 can be analyzed using one or more suitable methods, and an image of an interior volume of the turbine component 113 can be generated by reconstruction of the captured reflected signals. The computing devices(s) 12 can utilize any number of software and/or hardware modules to detect anomalies in the image of the interior volume of the turbine component 113, which can help identify defects and/or failures in the turbine component 113. Using this information, a failure of turbine component 113 can be detected at a relatively early stage, and corrective measures can be taken to prevent or otherwise minimize relatively major or catastrophic failures and associated costs.

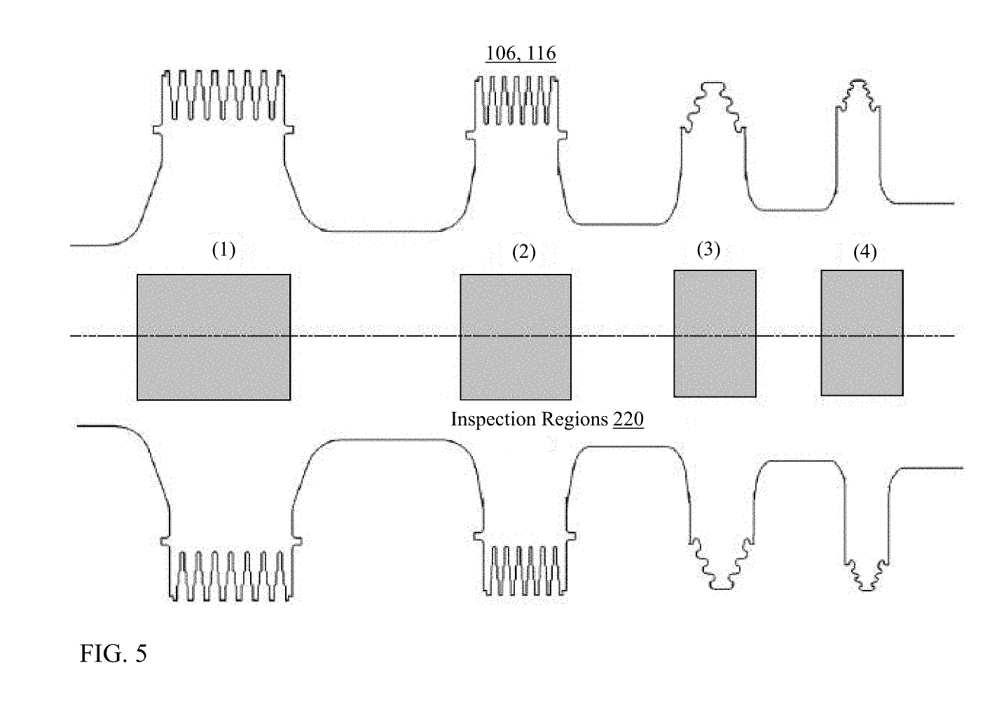

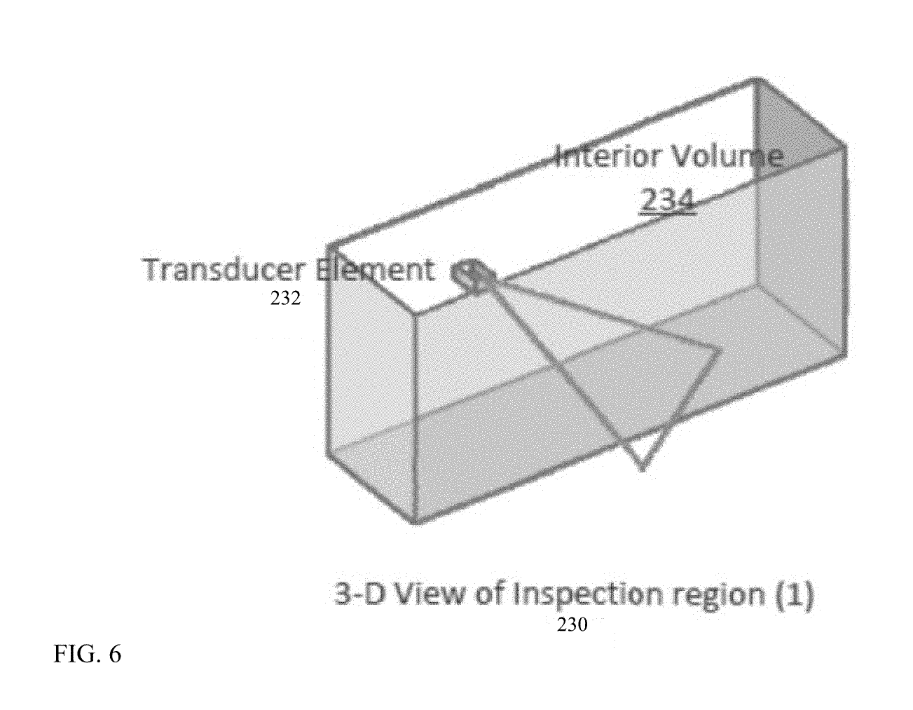

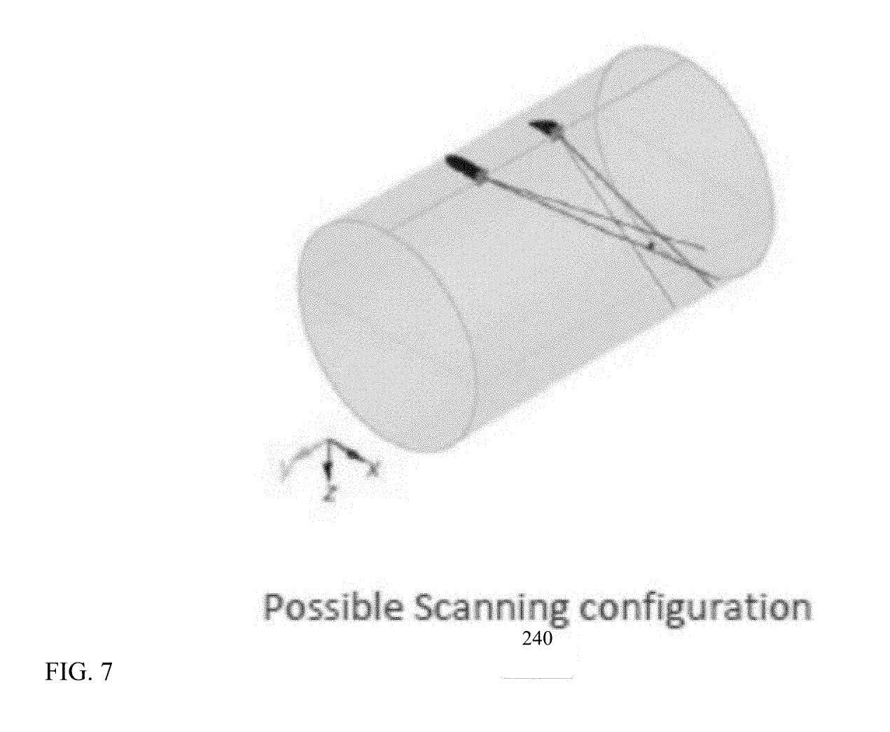

Referring now to FIG. 5, in accordance with an embodiment of the disclosure, a close-up view of a portion of rotor 106, 116 is shown along with inspection regions 220 for implementing certain methods and systems for ultrasonic inspection of turbine components, in accordance with one or more example embodiments. For reference, various inspection regions 220 are labeled (1) through (4). Each inspection region shown can be part of a volume of the rotor geometry to be scanned. Referring now to the view of inspection region (1) in FIG. 6, a 3-D view of the inspection region (1) 230 can include a transducer element 232 and an interior volume 234. The interior volume 234 can represent the three dimensional scanning volume whose image can be generated by digital reconstruction of the captured reflected signals. The transducer element 232 can be part of the transducer array 123 that can be mounted on the turbine rotor 106, 116. As illustrated in FIG. 7, a possible scanning configuration 240 is shown. While one possible scanning configuration 240 is illustrated, several other possible scanning configurations can be implemented in various embodiments of the disclosure.

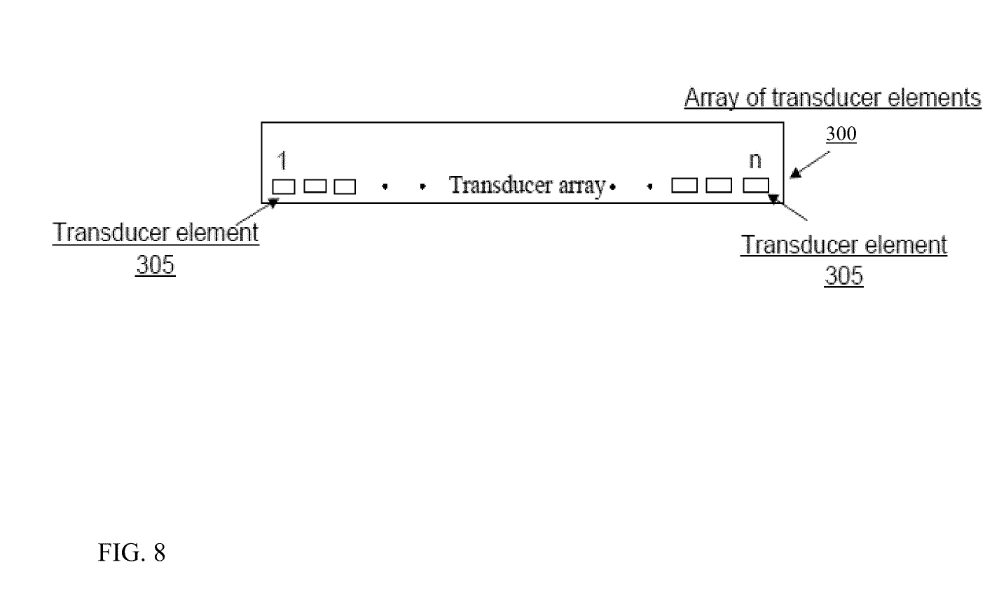

Referring now to FIG. 8, in accordance with some embodiments of the present disclosure, at least one array of transducer elements 123 is mounted to a turbine component, such as 113 in FIG. 4. As shown in the figure, the at least one array of transducer elements 123 can include transducer elements or probes 305 numbered 1 to n. Each transducer element 305 acts as a transmitter 320 and a receiver 330.

During the full matrix capture process, each transducer element 305 can be pulsed to transmit an ultrasonic signal to the turbine component (not shown). Each transducer element 305 of the array of transducer elements 300 captures the reflected signals from the turbine component. The captured reflected signals at each transducer element 305 can be recorded and stored for post-processing. A second, third, fourth and so on transducer element 305 can then be pulsed in sequence until the process all the n transducer elements have been pulsed and the captured reflected signal from the turbine component from all the n elements have been recorded and stored for post-processing.

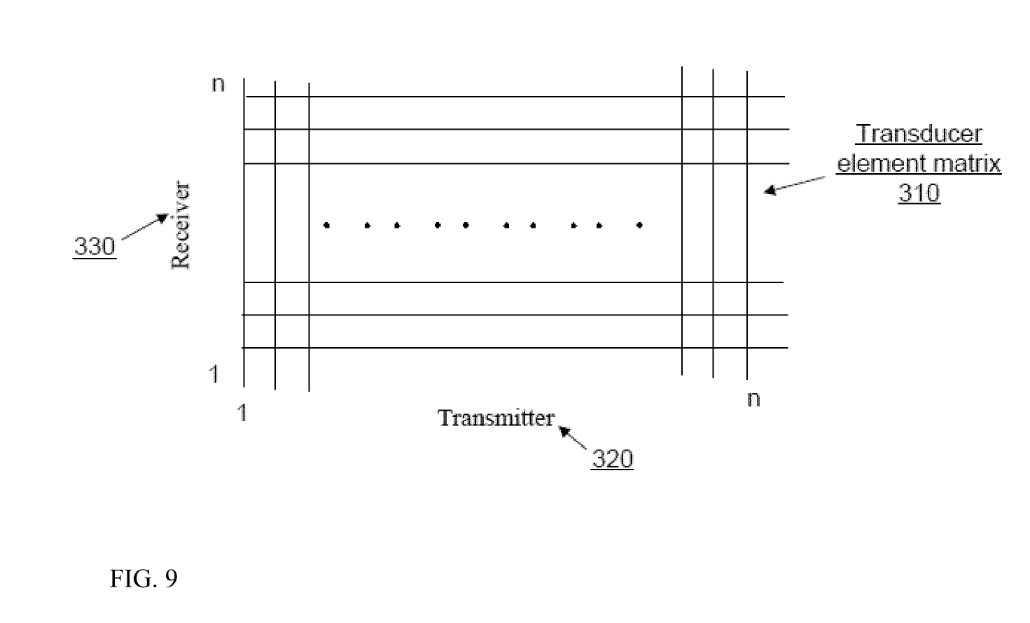

The full matrix process illustrated herein can result in a two dimensional transducer element matrix (n by n) 310 as shown in FIG. 9, where each receiving transmitter element (receiver 330) can receive and store signals from the pulse from each transmitting element (transmitter 320). The two dimensional transducer element matrix 310 can allow for three dimensional scanning of the interior volume, such as 234 in FIG. 6. In various embodiments, the three dimensional scanning of the interior volume 234 can be used to reconstruct an image of the interior volume 234 of the turbine component 110 using captured reflected signals from multiple beam angles, such as, for example, scanning with various skew (azimuth) and theta (refracted) beam angles.

Referring again to the two dimensional matrix 310 of FIG. 9, the data received from each element of the two dimensional matrix 310 can be recorded as a time series. The resultant data signal from each transmitting element (transmitter 320) can be captured by each receiving element (receiver 330) over time can be a three dimensional matrix of n by n by time samples.

The above description of the matrix in FIG. 9 illustrates data captured using a pulse-echo mode, where each transducer element 305 (FIG. 8) can transmit a signal and receive the reflected signal from the turbine component 113. In another embodiment, data can be captured in a similar matrix using a pitch-catch mode, where one set of transducer elements 305 or one transducer array 123 can be used to transmit signals (transmitter 320), while another set of transducer elements 305 or another transducer array 123 can act as receiver elements (receiver 330).

FIG. 10 shows an illustrative environment 401 including ultrasonic control system 14, for performing the functions described herein according to various embodiments of the invention. To this extent, the environment 401 includes a computer system 402 that can perform one or more processes described herein in order to monitor and/or control system 10 (FIG. 1). In particular, the computer system 402 is shown as including the ultrasonic control system 14, which makes computer system 402 operable to control/monitor turbomachine rotor 106, 116 by performing any/all of the processes described herein and implementing any/all of the embodiments described herein.

The computer system 402 is shown including computing device 12, which can include a processing component 404 (e.g., one or more processors), a storage component 406 (e.g., a storage hierarchy), an input/output (I/O) component 408 (e.g., one or more I/O interfaces and/or devices), and a communications pathway 410. In general, the processing component 404 executes program code, such as the ultrasonic control system 14, which is at least partially fixed in the storage component 406. While executing program code, the processing component 404 can process data, which can result in reading and/or writing transformed data from/to the storage component 406 and/or the I/O component 408 for further processing. The pathway 410 provides a communications link between each of the components in the computer system 402. The I/O component 408 can comprise one or more human I/O devices, which enable a user (e.g., a human and/or computerized user) 412 to interact with the computer system 402 and/or one or more communications devices to enable the system user 412 to communicate with the computer system 402 using any type of communications link. To this extent, the ultrasonic control system 14 can manage a set of interfaces (e.g., graphical user interface(s), application program interface, etc.) that enable human and/or system users 412 to interact with the ultrasonic control system 14. Further, the ultrasonic control system 14 can manage (e.g., store, retrieve, create, manipulate, organize, present, etc.) data, such as ultrasonic detection data 60 and/or ultrasonic representation data 70 using any solution, e.g., via wireless and/or hardwired means.

In any event, the computer system 402 can comprise one or more general purpose computing articles of manufacture (e.g., computing devices) capable of executing program code, such as the ultrasonic control system 14, installed thereon. As used herein, it is understood that “program code” means any collection of instructions, in any language, code or notation, that cause a computing device having an information processing capability to perform a particular function either directly or after any combination of the following: (a) conversion to another language, code or notation; (b) reproduction in a different material form; and/or (c) decompression. To this extent, the ultrasonic control system 14 can be embodied as any combination of system software and/or application software. It is further understood that the ultrasonic control system 14 can be implemented in a cloud-based computing environment, where one or more processes are performed at second computing devices (e.g., a plurality of computing devices 12), where one or more of those second computing devices may contain only some of the components shown and described with respect to the computing device 12 of FIG. 10.

Further, ultrasonic control system 14 can be implemented using a set of modules 432. In this case, a module 432 can enable the computer system 402 to perform a set of tasks used by the ultrasonic control system 14, and can be separately developed and/or implemented apart from other portions of the ultrasonic control system 14. As used herein, the term “component” means any configuration of hardware, with or without software, which implements the functionality described in conjunction therewith using any solution, while the term “module” means program code that enables the computer system 402 to implement the functionality described in conjunction therewith using any solution. When fixed in a storage component 406 of a computer system 402 that includes a processing component 404, a module is a substantial portion of a component that implements the functionality. Regardless, it is understood that two or more components, modules, and/or systems may share some/all of their respective hardware and/or software. Further, it is understood that some of the functionality discussed herein may not be implemented or additional functionality may be included as part of the computer system 402.

When the computer system 402 comprises multiple computing devices, each computing device may have only a portion of ultrasonic control system 14 fixed thereon (e.g., one or more modules 432). However, it is understood that the computer system 402 and ultrasonic control system 14 are only representative of various possible equivalent computer systems that may perform a process described herein. To this extent, in other embodiments, the functionality provided by the computer system 402 and ultrasonic control system 14 can be at least partially implemented by one or more computing devices that include any combination of general and/or specific purpose hardware with or without program code. In each embodiment, the hardware and program code, if included, can be created using standard engineering and programming techniques, respectively.

Regardless, when the computer system 402 includes multiple computing devices 12, the computing devices can communicate over any type of communications link. Further, while performing a process described herein, the computer system 402 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

While shown and described herein as a method and system for monitoring turbomachine rotor 106 (FIG. 1), 116 (FIG. 2), it is understood that aspects of the invention further provide various alternative embodiments. For example, in one embodiment, the invention provides a computer program fixed in at least one computer-readable medium, which when executed, enables a computer system to monitor turbomachine rotor 106 (FIG. 1), 116 (FIG. 2). To this extent, the computer-readable medium includes program code, such as the ultrasonic control system 14 (FIG. 10), which implements some or all of the processes and/or embodiments described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; paper; etc.

In another embodiment, the invention provides a method of providing a copy of program code, such as the ultrasonic control system 14 (FIG. 10), which implements some or all of a process described herein. In this case, a computer system can process a copy of program code that implements some or all of a process described herein to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of monitoring turbomachine rotor 106 (FIG. 1), 116 (FIG. 2). In this case, a computer system, such as the computer system 402 (FIG. 10), can be obtained (e.g., created, maintained, made available, etc.) and one or more components for performing a process described herein can be obtained (e.g., created, purchased, used, modified, etc.) and deployed to the computer system. To this extent, the deployment can comprise one or more of: (1) installing program code on a computing device; (2) adding one or more computing and/or I/O devices to the computer system; (3) incorporating and/or modifying the computer system to enable it to perform a process described herein; etc.

In any case, the technical effect of the various embodiments of the disclosure, including, e.g., ultrasonic control system 14, is to monitor turbomachine rotor, e.g., for potential faults. It is understood that according to various embodiments, ultrasonic control system 14 could be implemented to monitor a plurality of turbomachine rotors, such as turbomachine rotors 106 (FIG. 1), 116 (FIG. 2) described herein.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. An ultrasonic imaging method, performed using an ultrasonic detection system having a transmitting phased array device and a receiving phased array device, the method comprising:
transmitting, at the transmitting phased array device, a first set of ultrasonic waves through a first portion of a machine rotor at a first static position, and receiving, at the receiving phased array device, the first set of ultrasonic waves after transmission through the portion of the machine rotor, to obtain a first set of ultrasonic detection information about the machine rotor;
transmitting, at the transmitting phased array device, a second set of ultrasonic waves through a second portion of the machine rotor at a second static position, and receiving, at the receiving phased array device, the second set of ultrasonic waves after transmission through the second portion of the machine rotor, to obtain a second set of ultrasonic detection information about the machine rotor; and
forming an ultrasonic representation of the machine rotor by aligning the first set of ultrasonic detection information about the machine rotor with the second set of ultrasonic detection information about the machine rotor.

2. The method of claim 1, wherein one of the first portion of the machine rotor or the second portion of the machine rotor includes at least one of a rotor shaft, a rotor wheel, a rotor body, a coupling or a blade attachment.

3. The method of claim 1, wherein the transmitting phased array device and the receiving phased array device form an arrangement of phased array devices.

4. The method of claim 3, wherein the ultrasonic detection system further includes a plurality of arrangements of phased array devices.

5. The method of claim 4, wherein each arrangement of phased array devices obtains the ultrasonic detection information from a different position about the machine rotor.

6. The method of claim 1, further comprising:
transmitting, at the transmitting phased array device, a third set of ultrasonic waves through a third portion of the machine rotor at a third static position, and receiving, at the receiving phased array device, the third set of ultrasonic waves after transmission through the third portion of the machine rotor, to obtain a third set of ultrasonic detection information about the machine rotor; and
forming an ultrasonic representation of the machine rotor by aligning the first set of ultrasonic detection information with the second set of ultrasonic detection information and the third set of ultrasonic detection information.

7. The method of claim 6, wherein the transmitting and receiving of the third set of ultrasonic waves at the third static position are repeated for a plurality of third sets of ultrasonic waves at a plurality of third static positions until ultrasonic detection information is obtained from each of the third static positions.

8. The method of claim 1, wherein the transmitting and receiving phased array devices are housed within a same component.

9. The method of claim 1, wherein the transmitting phased array device is positioned relative to the receiving phased array device to generate a field through a predetermined volume of the machine rotor.

10. A system comprising:
an ultrasonic detection system for imaging a machine rotor, the ultrasonic detection system having a transmitting phased array device and a receiving phased array device; and
at least one computing device coupled with the ultrasonic detection system, the at least one computing device configured to:
instruct the transmitting phased array device to transmit a first set of ultrasonic waves through a first portion of a machine rotor at a first static position, and receive, from the receiving phased array device, the first set of ultrasonic waves after transmission through the portion of the machine rotor, to obtain a first set of ultrasonic detection information about the machine rotor;
instruct the transmitting phased array device to transmit a second set of ultrasonic waves through a second portion of the machine rotor at a second static position, and receive, at the receiving phased array device, the second set of ultrasonic waves after transmission through the second portion of the machine rotor, to obtain a second set of ultrasonic detection information about the machine rotor; and
form an ultrasonic representation of the machine rotor by aligning the first set of ultrasonic detection information about the machine rotor with the second set of ultrasonic detection information about the machine rotor.

11. The system of claim 10, wherein the portion of the machine rotor includes at least one of a rotor shaft, a rotor wheel, a rotor body, a coupling or a blade attachment.

12. The system of claim 10, wherein the transmitting phased array device and the receiving phased array device form an arrangement of phased array devices.

13. The system of claim 12, wherein the ultrasonic detection system further comprises a plurality of arrangements of phased array devices.

14. The system of claim 13, wherein each arrangement of phased array devices obtains the ultrasonic detection information from a different position about the machine rotor.

15. The system of claim 10, wherein the at least one computing device is further configured to:
instruct the transmitting phased array device to transmit a third set of ultrasonic waves through a third portion of the machine rotor at a third static position, and receive, from the receiving phased array device, the third set of ultrasonic waves after transmission through the third portion of the machine rotor, to obtain a third set of ultrasonic detection information about the machine rotor; and
form an ultrasonic representation of the machine rotor by aligning the first set of ultrasonic detection information with the second set of ultrasonic detection information and the third set of ultrasonic detection information.

16. The method of claim 15, wherein the transmitting and receiving of the third set of ultrasonic waves at the third static position are repeated for a plurality of sets of third ultrasnoic waves at a plurality of third static positions until ultrasonic detection information is obtained from each of the third static positions.

17. The system of claim 10, wherein the transmitting and receiving phased array devices are housed within a same component.

18. The system of claim 10, wherein the transmitting phased array device is positioned relative to the receiving phased array device to generate a field through a predetermined volume of the machine rotor.

19. An ultrasonic imaging method, performed using an ultrasonic detection system having a set of corresponding transmitting phased array devices and receiving phased array devices, the method comprising:
for each of a plurality of static positions about a portion of a machine rotor:
transmitting, at a corresponding transmitting phased array device, a set of ultrasonic waves through the portion of the machine rotor, and receiving, at the corresponding receiving phased array device, the set of ultrasonic waves after transmission through the portion of the machine rotor, to obtain a set of ultrasonic detection information about the machine rotor; and
forming an ultrasonic representation of the machine rotor by aligning the sets of the ultrasonic detection information about the machine rotor obtained from each of the plurality of static positions about the portion of the machine rotor.

20. The method of claim 19, wherein the portion of the machine rotor includes at least one of a rotor shaft, a rotor wheel, a rotor body, a coupling or a blade attachment.
